(19) United States
(12) Patent Application Publication
(10) Pub. No.: US 2005/0111208 A1
(43) Pub. Date: May 26, 2005

(54) Surface light source device and liquid crystal display apparatus having the same

(76) Inventors: Hae-Il Park, Seoul (KR); Sang-Yu Lee, Yongin-si (KR); Jin-Seob Byun, Seoul (KR)

Correspondence Address: CANTOR COLBURN LLP, 55 Griffin Road South, Bloomfield, CT, 06002, US

(21) Appl. No.: 10/911,146

(22) Filed: Aug. 4, 2004

(30) Foreign Application Priority Data
Nov. 20, 2003 (KR) 2003-82481

(51) Int. Cl. G01D 11/28

(52) U.S. Cl. 362/29; 362/97

(57) ABSTRACT

A surface light source device includes a light source body having a plurality of partitioned discharge spaces extended in a first direction, first, second and third electrodes. The first and second electrodes are disposed at each end portion of the light source body, respectively and extended in a second direction that crosses the first direction. The third electrode is extended in the second direction, and the third electrode is disposed between the first and second electrodes, such that the third electrode overlaps with the partitioned discharge spaces. A discharge start voltage is applied to the third electrode that overlaps with partition member, so that deflection caused by interference between the partition members is reduced. Additionally, the discharge voltage is lowered.

### CROSS-REFERENCE TO RELATED APPLICATIONS

This application relies for priority upon Korean Patent Application No.2003-82481 filed on Nov. 20, 2003, the contents of which are herein incorporated by reference in its entirety.

### BACKGROUND OF THE INVENTION

1. Field of the Invention

The present invention relates to a surface light source device and a liquid crystal display apparatus having the surface light source device. More particularly, the present invention relates to a surface light source device having a light source body and a partition member dividing the light source body to form partitioned discharge spaces, and a liquid crystal display apparatus having the surface light source device.

2. Description of the Related Art

Recently, information processing devices having various shapes, functions, and rapid processing speed have been developed. Information processed by the information processing device corresponds to electric signals. Therefore, users require display apparatuses in order to perceive the information.

A liquid crystal display apparatus that is an example of the display apparatuses displays an image by using liquid crystal. The liquid crystal display has lightweight, thin thickness, low power consumption and low driving voltage. Therefore, the liquid crystal display apparatus is widely used.

The liquid crystal display panel does not emit light. Therefore, the liquid crystal display panel requires a backlight assembly that provides the liquid crystal display apparatus crystal display panel with a light.

A conventional backlight assembly is classified into an edge illumination type and a direct illumination type.

In the edge illumination type backlight assembly, a light source is disposed at side of a light guide plate, so that a light generated from the light source enters the light guide plate through the side of the light guide plate and exits the light guide plate toward the liquid crystal display panel through an upper surface of the light guide plate.

In the direct illumination type backlight assembly, a light source is disposed under the liquid crystal display panel, and a light diffusion plate is disposed between the liquid crystal display panel and the light source to diffuse a light generated from the light source.

The direct illumination type backlight assembly provides a light of high luminance, but the direct illumination type backlight assembly has low uniformity of luminance. On the contrary, the edge illumination type backlight assembly provides a light of high uniformity, but the edge illumination type backlight assembly provides a light of low luminance.

A cold cathode fluorescent lamp (CCFL) having a cylindrical shape, or a light emitting diode (LED) having a dot shape may be used as the light source of the backlight assembly. The CCFL has a high luminance and a long life span, and generates a small amount of heat. The LED is small in size, and has low power consumption. However, the conventional backlight assembly having the CCFL or the LED as the light source has a problem of low luminance and low uniformity of the luminance.

Therefore, a backlight assembly having the CCFL or the LED requires a light guide plate, a diffusion member, a prism sheet, etc., in order to enhance luminance and uniformity of the luminance, so that the liquid crystal display apparatus has increased in volume and weight. Furthermore, a manufacturing cost is increased.

In order to solve above problems, a surface light source device has been developed. The surface light source device includes a light source body having a discharge space, and a partition member disposed inside of the light source body to divide the discharge space into a plurality of partitioned discharge spaces. Additionally, the surface light source device includes electrodes disposed inside or outside of the light source body in order to generate plasma in the discharge space.

However, in the conventional surface light source device, a cross talk between the partitioned discharge spaces occurs to induce deflection. That is, electric charges gather together around edges of the partition member. Therefore, light emission is lowered. Furthermore, when a size of the surface light source device increases, a discharge start voltage is raised.

### SUMMARY OF THE INVENTION

The present invention provides a surface light source device capable of removing deflection induced by a cross talk between partitioned discharge spaces to enhance the light emission, and lowering a discharge start voltage.

The present invention also provides a liquid crystal display apparatus having the above-mentioned surface light source device.

In an exemplary surface light source device according to the present invention, a surface light source device includes a light source body, first, second and third electrodes. The light source body includes a plurality of partitioned discharge spaces extended in a first direction. The first and second electrodes are disposed at each end portion of the light source body, respectively and extended in a second direction crosses the first direction. The third electrode is extended in the second direction, and the third electrode is disposed between the first and second electrodes, such that the third electrode overlaps with the partitioned discharge spaces.

In an exemplary liquid crystal display apparatus according to the present invention, the liquid crystal display apparatus includes a surface light source device, a liquid crystal display panel and an inverter. The surface light source device includes a light source body, first, second and third electrodes. The light source body includes a plurality of partitioned discharge spaces extended in a first direction. The first and second electrodes are disposed at each end portion of the light source body, respectively and extended in a second direction that crosses the first direction. The third electrode is extended in the second direction, and the third electrode is disposed between the first and second electrodes, such that the third electrode overlaps with the partitioned discharge spaces. The liquid crystal display panel displays an image by using the light generated from the surface light source device. The inverter applies discharge voltage including a discharge start voltage and a discharge maintaining voltage to the first, second and third electrodes.

According to the present invention, a discharge start voltage is applied to an electrode that overlaps with partition member, so that deflection caused by interference between the partition members is reduced. Additionally, the discharge voltage is lowered.

Furthermore, a floating electrode that overlaps with the partition member and a passage of the discharge gas to remove deflection while a discharge maintaining voltage is applied.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a partially cutout perspective view illustrating a surface light source device according to a first exemplary embodiment of the present invention;

FIG. 2 is a cross-sectional view taken along a line I-I′ in FIG. 1;

FIG. 3 is a cross-sectional view taken along a line II-II′ In FIG. 1;

FIG. 4 is a plan view illustrating an arrangement of partition members in FIG. 1;

FIG. 5 is a schematic view illustrating an operation of the surface light source device in FIG. 1;

FIG. 6 is a schematic view illustrating an operation of a surface light source device according to a second exemplary embodiment of the present invention;

FIG. 7 is a plan view illustrating an arrangement of partition members of a surface light source device according to a third exemplary embodiment of the present invention;

FIG. 8 is a schematic view illustrating an operation of a surface light source device in FIG. 7; and

FIG. 9 is an exploded perspective view illustrating a liquid crystal display apparatus according to a fourth exemplary embodiment of the present invention.

### DESCRIPTION OF PREFERRED EMBODIMENTS

Hereinafter, the preferred embodiments of the present invention will be described in detail with reference to the accompanied drawings.

Embodiments of Surface Light Source Devices

### Embodiment 1

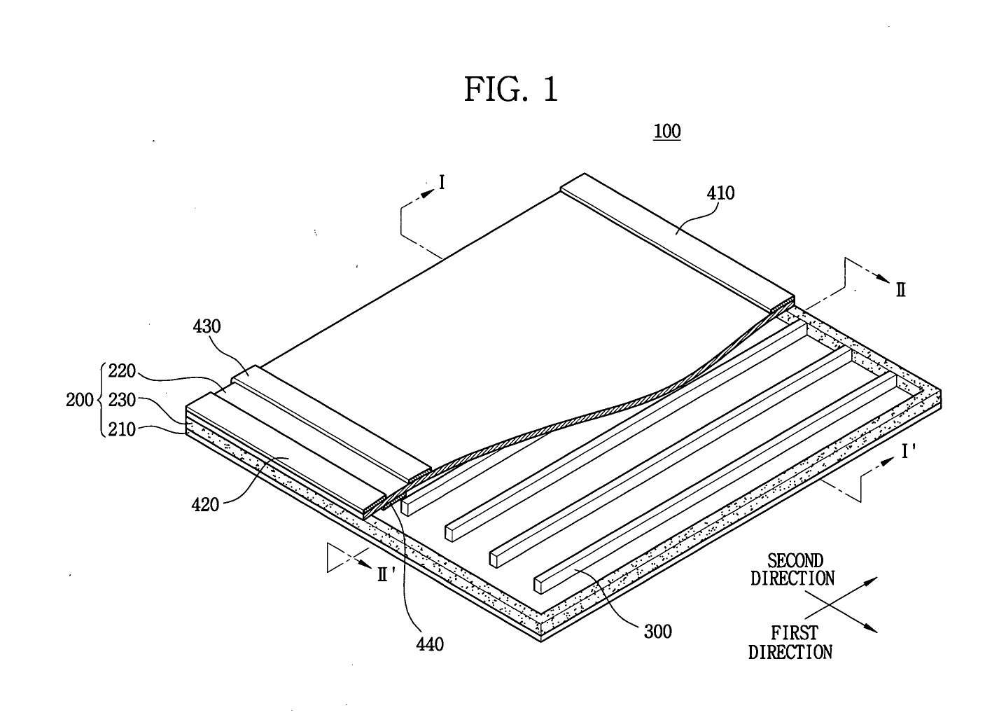

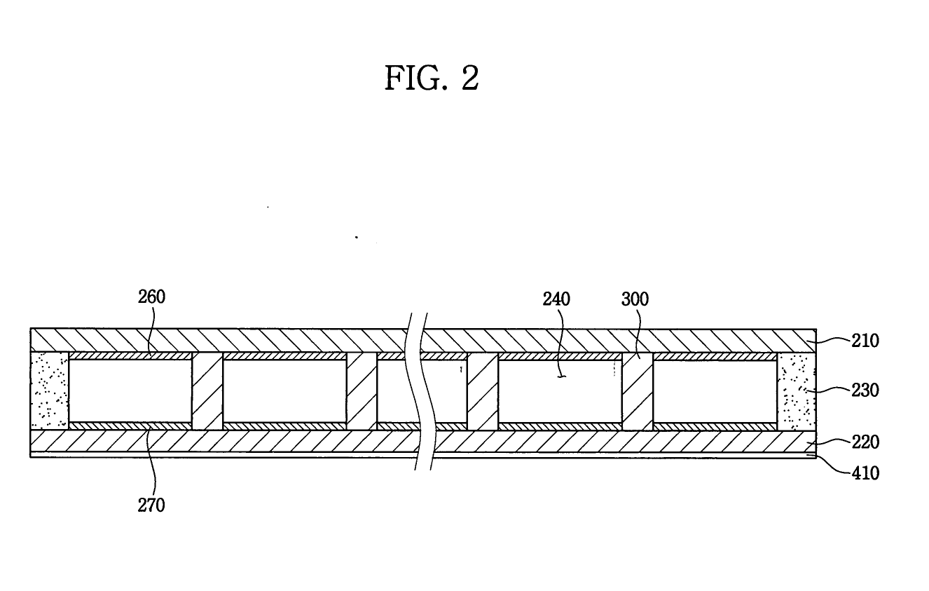

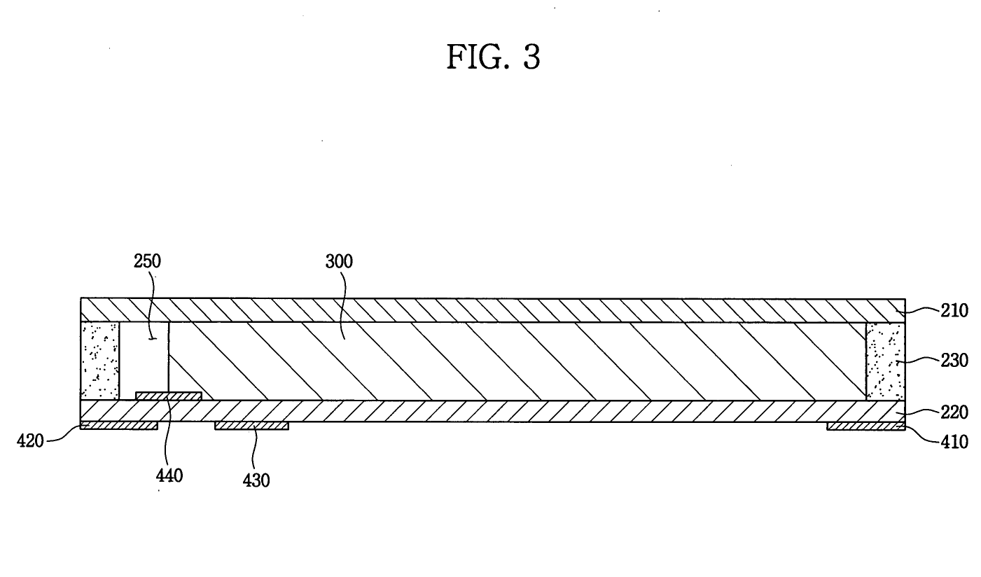

FIG. 1 is a partially cutout perspective view illustrating a surface light source device according to a first exemplary embodiment of the present invention. FIG. 2 is a cross-sectional view taken along a line I-I′ in FIG. 1, and FIG. 3 is a cross-sectional view taken along a line II-II′ In FIG. 1. In FIGS. 2 and 3, the surface light source device is disposed upside down with respect to FIG. 1.

Referring to FIGS. 1 to 3, a surface light source device 100 according to a first exemplary embodiment of the present invention includes a light source body 200, a partition member 300, a first electrode 410, a second electrode 420 and a third electrode 430.

The light source body 200 includes a first substrate 210, a second substrate 220 and a sealing member 230. The first and second substrates 210 and 220 face each other. The sealing member 230 is interposed between the first and second substrates 210 and 220 along edge of the first and second substrates 210 and 220 to form a discharge space.

The first and second substrates 210 and 220 are a glass substrate that transmits a visible light and blocks an ultraviolet light. For example, a thickness of the first substrate 210 is substantially same as a thickness of the second substrate 220. Alternatively, a thickness of the first substrate 210 may be smaller than a thickness of the second substrate 220.

The sealing member 230 disposed between the first and second substrates 210 and 220 defines the discharge space. The sealing member 230 may be integrally formed with the first substrate 210 or the second substrate 220.

The partition member 300 is disposed in the discharge space of the light source body 200. At least one partition member 300 may be disposed in parallel by a substantially same distance to divide the discharge space into partitioned discharge spaces 240.

Each partition member 300 has a bar shape extended in a first direction. Lower and upper surfaces of the partition member 300 are attached to the first and second substrates 210 and 220, respectively. One end of the partition member 300 is spaced apart from an internal surface of the sealing member 230 to form a passage 250 of discharge gas. Therefore, the discharge gas disposed inside the discharge space may be uniformly distributed.

The sealing member 230 and the partition member 300 may include same material, so that the sealing member 230 may be formed through a process of forming the partition member 300. Alternatively, the sealing member 230 and the partition member 300 may include different material from each other.

The first and second electrodes 410 and 420 are disposed at each end of the light source body 200, respectively, and extended in a second direction that is substantially perpendicular to the first direction. Alternatively, the first and second electrodes 410 and 420 may form an acute angle with respect to the partition member 300. For example, the first and second electrodes 410 and 420 are disposed on outer surface of the second substrate 220. However, the first and second electrodes 410 and 420 also may be formed on an outer surface of the first substrate 210. Furthermore, the first and second electrodes 410 and 420 may have rectangular ring shape to receive the light source body 200. A discharge maintaining voltage for maintaining discharge of the discharge gas is applied to the first and second electrodes 410 and 420.

The third electrode 430 is extended in the second direction and disposed between the first and second electrodes 410 and 420. The third electrode 430 is disposed on an outer surface of the second substrate 220, and the third electrode 430 overlaps with the partition member 300. A discharge start voltage for inducing discharge of the discharge gas is applied to the first and third electrodes 410 and 430.

The first, second and third electrodes 410, 420 and 430 include material having high conductivity such as copper (Cu), nickel (Ni), aluminum (Al) tape, silver (Ag) paste, etc. The first, second and third electrodes 410, 420 and 430 have sufficient surface area in order to provide sufficient excitation energy.

The surface light source device 100 of the present embodiment further includes a fourth electrode 440 disposed inside the light source body 200.

The fourth electrode 440 is extended in the second direction, and the fourth electrode 440 is disposed on an internal surface of the second substrate 220. The fourth electrode 440 partially or entirely overlaps with the second electrode 420. The fourth electrode 440 also overlaps with passage 250 and the partition member 300. The fourth electrode 440 corresponds to a floating electrode having no external voltage applied thereto.

The surface light source device 100 further includes first and second fluorescent layers 260 and 270 formed on the first and second substrates 210 and 220, respectively. A third fluorescent layer (not shown) may also be formed on side surface of the partition member 300. The first and second fluorescent layers 260 and 270 convert an ultraviolet light generated from discharge gas into a visible light.

Additionally, the surface light source device 100 may include a reflection layer (not shown) that is interposed between the second substrate 220 and the second fluorescent layer 270. The reflection layer reflects the visible light generated from the first and second fluorescent layers 260 and 270 toward the first substrate 260.

The surface light source device 100 may include a protection layer (not shown) that is interposed between the second substrate 220 and the reflection layer. The protection layer prevents chemical reaction between the discharge gas of the discharge space and the first and second substrates 210 and 220.

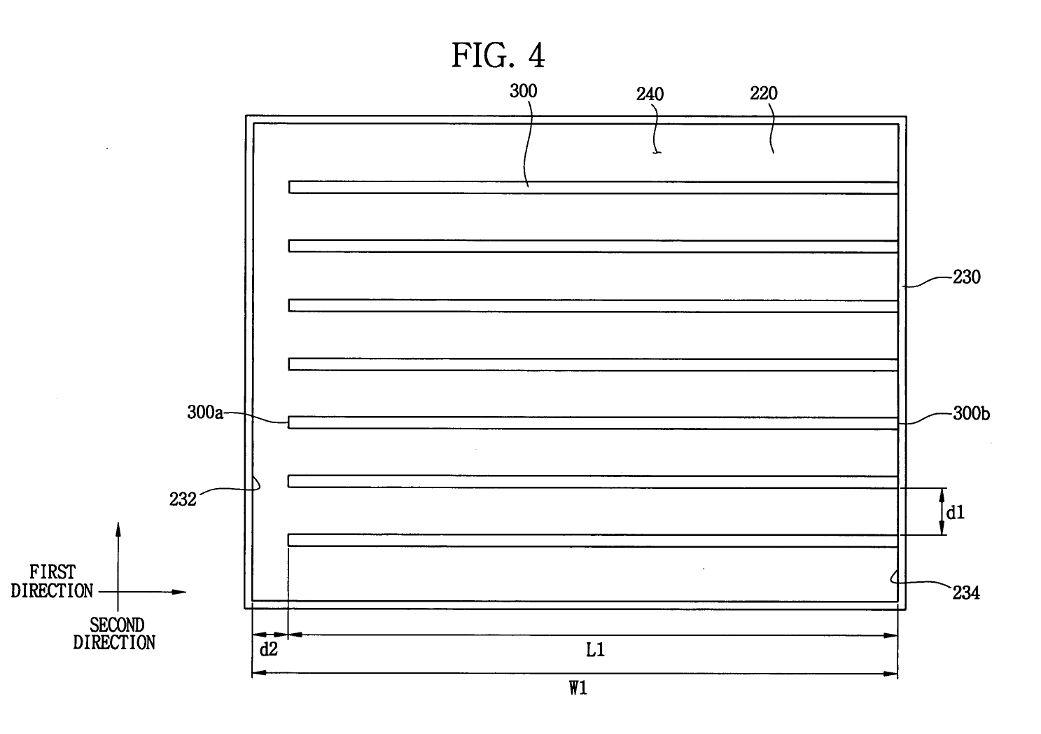

FIG. 4 is a plan view illustrating an arrangement of partition members in FIG. 1.

Referring to FIG. 4, at least one partition member 300 is interposed between the first and second substrates 210 and 220 to divide a partition space into a plurality of partition regions 240. The partition member 300 may be formed on the first substrate 210 or the second substrate 220. For example, the partition member 300 is formed on the second substrate 220.

The partition members 300 are spaced apart from each other by a first distance d1. Each of the partition members 300 has a bar shape having a first length L1. The first length L1 is less than a first width W1 between first and second internal surfaces 232 and 234 of the sealing member 230.

Each partition member 300 has first and second end portions 300a and 300b. The first end portion 300a of the partition member 300 faces the first internal surface 232, and the second end portion 300b of the partition member 300 faces the second internal surface 234. The second end portion 300b is attached to the second internal surface 234, and the first end portion 300a is spaced apart from the first internal surface 232 by a second distance d2 to form a passage 250. Therefore, discharge gas may flow through the passage 250, so that the discharge gas is distributed throughout the partitioned discharge spaces 240.

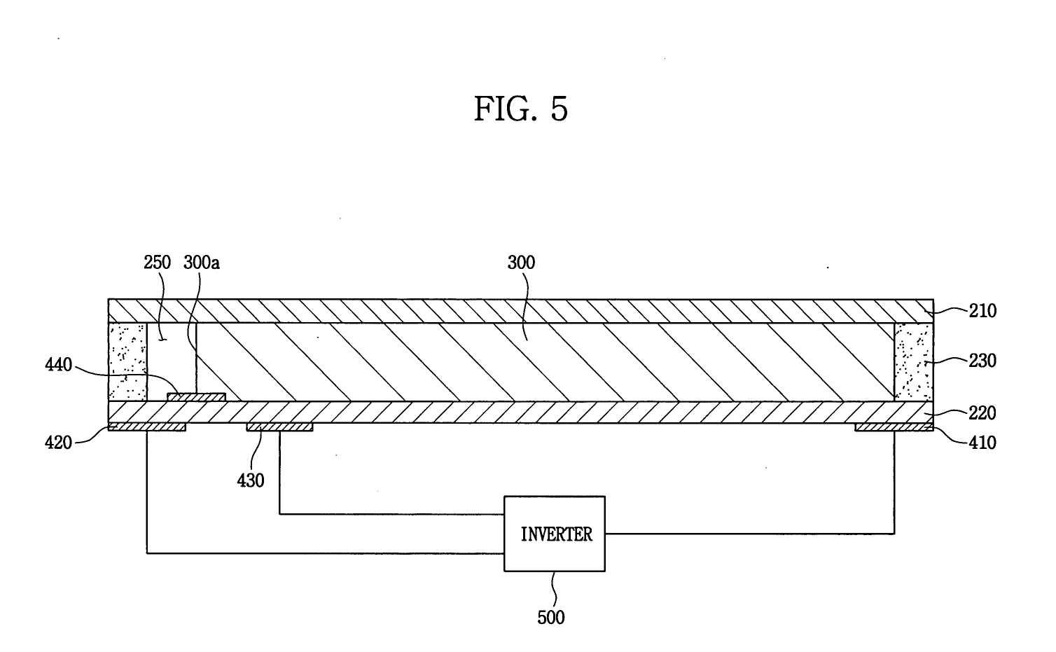

FIG. 5 is a schematic view illustrating an operation of the surface light source device in FIG. 1. Referring to FIG. 5, a surface light source device 100 according to the first exemplary embodiment of the present invention further includes an inverter 500 that generates a discharge voltage including a discharge start voltage and a discharge maintaining voltage.

First and second electrodes 410 and 420 are disposed at each end portion of a second substrate 220, respectively. A third electrode 430 is interposed between the first and second electrodes 410 and 420, such that a distance between the third and second electrodes 430 and 420 is smaller than a distance between the third and first electrodes 430 and 410. A discharge gas (not shown) is disposed in a discharge space of a light source body 200. The discharge gas includes mercury (Hg), neon (Ne), etc. The discharge gas may further include a small amount of argon (Ar), krypton (Kr), xenon (Xe), etc., in order to induce a Penning effect lowering a discharge voltage.

The inverter 500 applies the discharge start voltage to the first and third electrodes 410 and 430. For example, an alternating voltage ranged about 1 to about 2 kV may be applied to the third electrode 430, and an alternating voltage that has substantially same magnitude but inversed phase with the alternating voltage that is applied to the third electrode 430, may be applied to the first electrode 410. Alternatively, one electrode of the first and third electrodes 410 and 430 is grounded and an alternating voltage may applied to the other electrode.

Then, plasma is generated in the partitioned discharge space between the first and third electrodes 410 and 430. The third electrode 430 is disposed in a region that is divided by the partition member 300 completely, so that plasma is generated uniformly in each partitioned discharge space. Therefore, deflection caused by interference between neighboring partitioned discharge spaces may be removed. Furthermore, a distance between the electrodes is decreased to lower the discharge start voltage.

After a first time interval t1, the inverter 500 does not apply the discharge start voltage to the first and third electrodes 410 and 430, but the inverter 500 applies the discharge maintaining voltage to the first and second electrodes 410 and 420. For example, an alternating voltage of about 600V to about 700V is applied to the first electrode 410, and an alternating voltage that has substantially same magnitude but inversed phase with the alternating voltage that is applied to the first electrode 410, may be applied to the second electrode 420.

Due to the discharge maintaining voltage applied to the first and second electrodes 410 and 420, plasma generated by the discharge start voltage is spread throughout the partitioned discharge spaces, and maintained.

A fourth electrode 440 is formed on an internal surface of the second substrate 220. The fourth electrode 440 overlaps with the first end portion 300a of the partition member 300 and the passage 250.

The fourth electrode 440 prevents a current generated by plasma from flowing through neighboring partitioned discharge space 240. Additionally, the second and fourth electrodes 420 and 440, and the second substrate 220 form a condenser, so that the current is distributed uniformly to remove the deflection.

### Embodiment 2

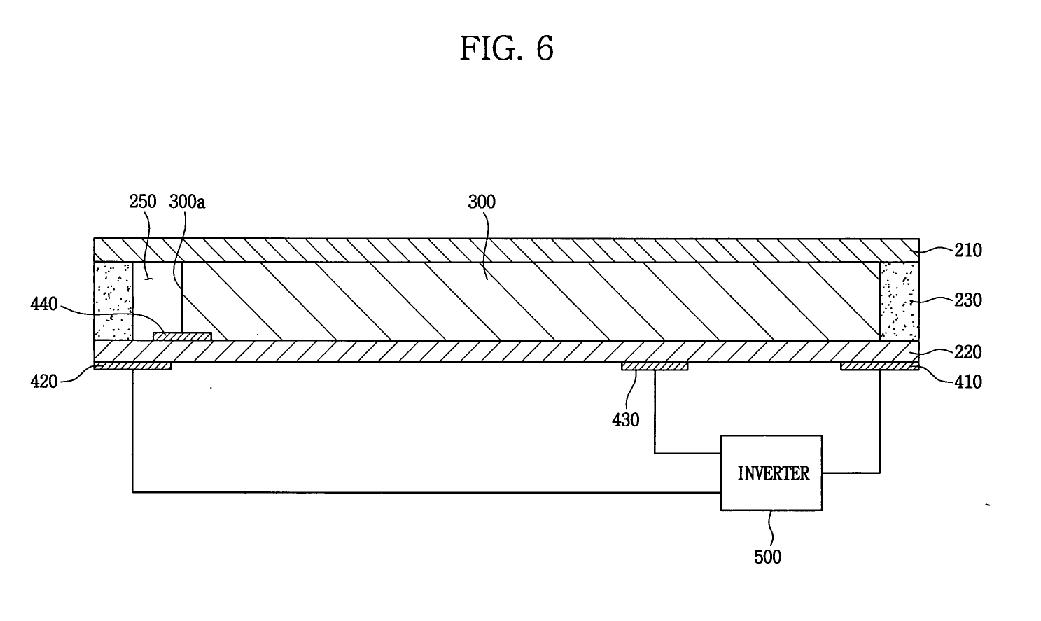

FIG. 6 is a schematic view illustrating an operation of a surface light source device according to a second exemplary embodiment of the present invention. The surface light source device of the present embodiment is same as the surface light source device in FIG. 5 except for a position of a third electrode. Thus, the same reference numerals will be used to refer to the same or like parts as those described in Embodiment 1 and any further explanation will be omitted.

Referring to FIG. 6, first and second electrodes 410 and 420 are disposed at each end portion of a second substrate 220, respectively. A third electrode 430 is disposed between the first and second electrodes 410 and 420, such that a distance between the first and third electrodes 410 and 430 is smaller than a distance between the second and third electrodes 420 and 430.

An inverter 500 applies a discharge start voltage to the first and third electrodes 410 and 430 to generate plasma in the partitioned discharge space between the first and third electrodes 410 and 430. The third electrode 430 is disposed in a region that is divided by the partition member 300 completely, so that plasma is generated uniformly in each partitioned discharge space. Therefore, deflection caused by interference between neighboring partitioned discharge spaces may be removed. Furthermore, since a distance between the electrodes is decreased more than that of the electrodes of the surface light source device in FIG. 5, the discharge start voltage is more lowered.

After a first time interval t1, the inverter 500 does not apply the discharge start voltage to the first and third electrodes 410 and 430, but the inverter 500 applies the discharge maintaining voltage to the first and second electrodes 410 and 420. Due to the discharge maintaining voltage applied to the first and second electrodes 410 and 420, plasma generated by the discharge start voltage is spread throughout the partitioned discharge spaces, and maintained.

### Embodiment 3

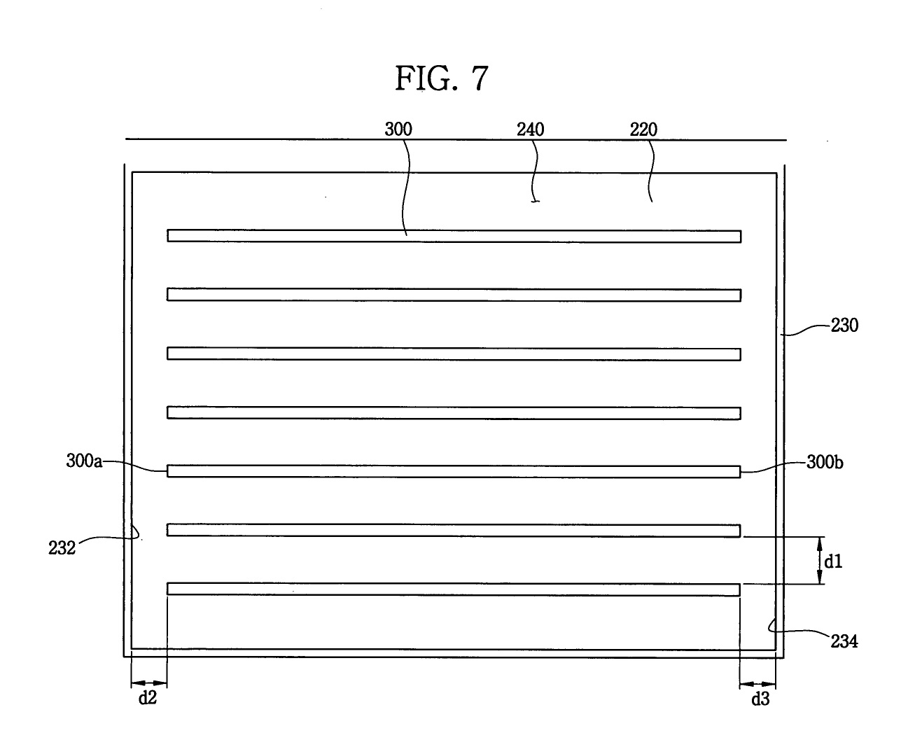

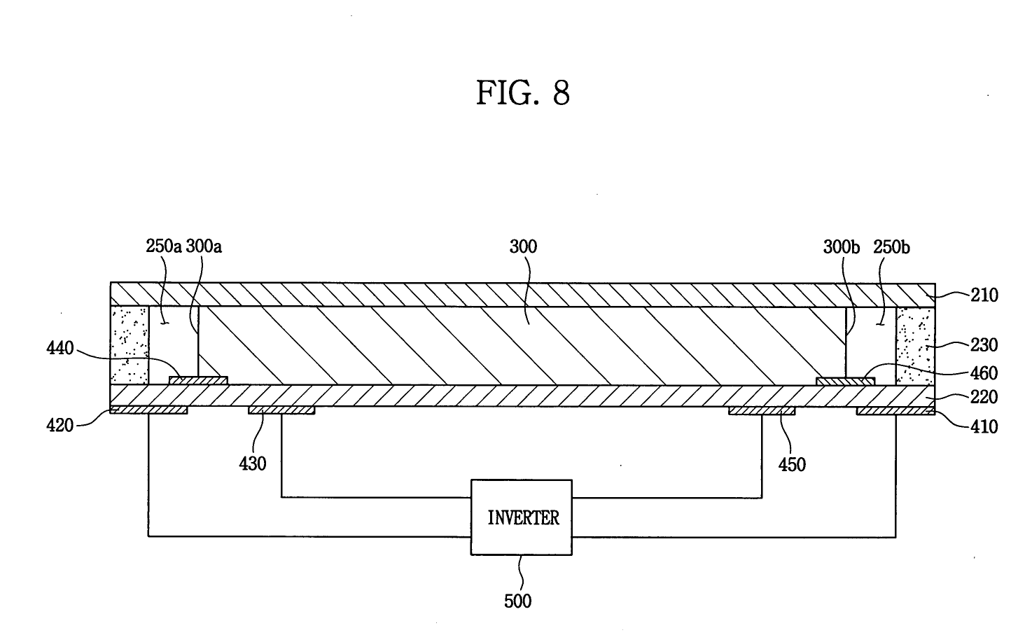

FIG. 7 is a plan view illustrating an arrangement of partition members of a surface light source device according to a third exemplary embodiment of the present invention, and FIG. 8 is a schematic view illustrating an operation of a surface light source device in FIG. 7.

Referring to FIGS. 7 and 8, at least one partition member 300 is formed on a second substrate 200 to divide a discharge space into a plurality of partitioned discharge spaces 240.

Each partition member 300 is spaced apart from neighboring partition member 300 by a first distance d1. A first end portion 300a of the partition member 300 is spaced apart from a first internal surface 232 of a sealing member 230 by a second distance d2 to form a first passage 250a, and a second end portion 300b of the partition member 300 is spaced apart from a second internal surface 234 of a sealing member 230 by a third distance d3 to form a second passage 250b. Preferably, the second and third distances d2 and d3 are substantially same.

When the first and second passages 250a and 250b are formed, discharge gas is spread uniformly throughout all partitioned discharge spaces promptly.

First, second, third and fifth electrodes 410, 420, 430 and 450 are disposed on an outer surface of the second substrate 220, and fourth and sixth electrodes 440 and 460 are disposed on an internal surface of the second substrate 220.

The first and second electrodes 410 and 420 are disposed at each end portion of the second substrate 220, respectively. The third and fifth electrodes 430 and 450 are interposed between the first and second electrodes 410 and 420. The third and fifth electrodes 430 and 450 are adjacent to the second and first electrodes 420 and 420, respectively. Both the third and fifth electrodes 430 and 450 overlap with the partition member 300.

The fourth electrode 440 overlaps with the first end portion 300a of the partition member 300 and the first passage 250a, and the sixth electrode 460 overlaps with the second end portion 300b of the partition member 300 and the second passage 250b.

An inverter 500 applies a discharge start voltage to the third and fifth electrodes 430 and 450 during a first time interval t1 to generate plasma in the partitioned discharge space. The third and fifth electrodes 430 and 450 are disposed in a region that is divided by the partition member 300. The plasma generated by the third and fifth electrodes 430 and 450 spreads out uniformly in each partitioned discharge space. Therefore, deflection caused by interference between neighboring partitioned discharge spaces may be removed. Furthermore, a distance between the electrodes is decreased to lower the discharge start voltage.

After the first time interval t1, the inverter 500 does not apply the discharge start voltage to the third and fifth electrodes 430 and 450, but the inverter 500 applies the discharge maintaining voltage to the first and second electrodes 410 and 420. Due to the discharge maintaining voltage applied to the first and second electrodes 410 and 420, plasma generated by the discharge start voltage is spread throughout the partitioned discharge spaces, and maintained.

The fourth and sixth electrodes 440 and 460 prevent a current generated by plasma from flowing through neighboring partitioned discharge space 240. Additionally, the first and sixth electrodes 410 and 460, the second and fourth electrodes 420 and 440, and the second substrate 220 form a condenser, so that the current is distributed uniformly to remove the deflection.

Embodiment of Liquid Crystal Display Apparatus

### Embodiment 4

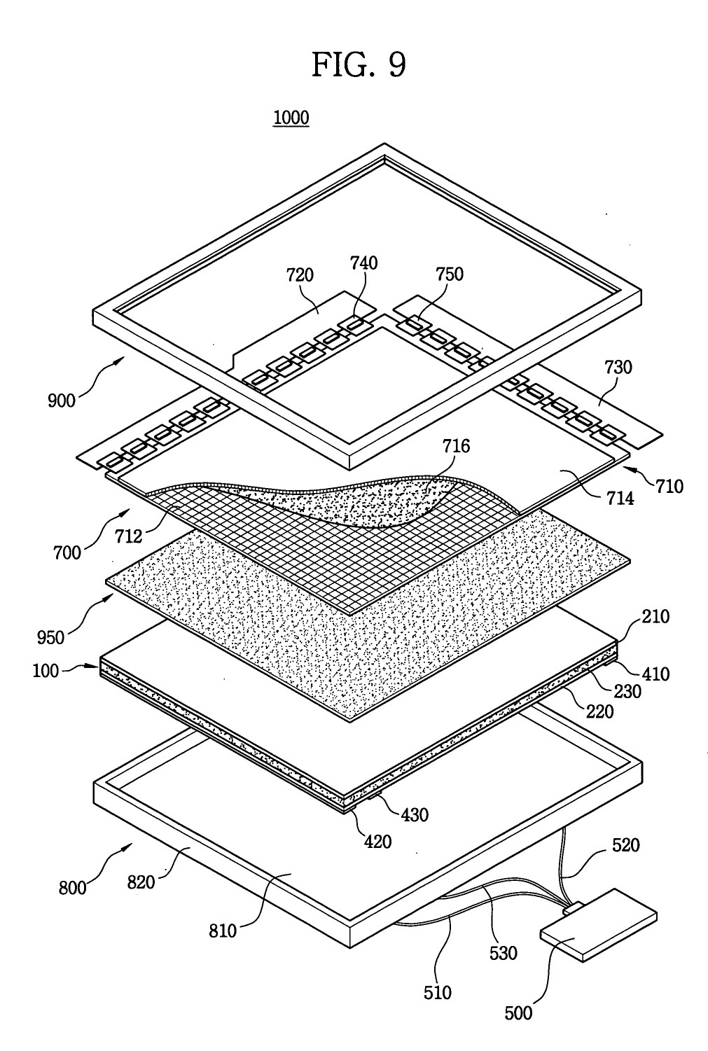

FIG. 9 is an exploded perspective view illustrating a liquid crystal display apparatus according to a fourth exemplary embodiment of the present invention.

Referring to FIG. 9, a liquid crystal display apparatus 1000 includes a surface light source device 100, a display unit 700, a receiving container 800 and an inverter 500. For example, the liquid crystal display apparatus 1000 employs surface light source device in FIG. 1.

The display unit 700 includes a display panel 710, data and gate printed circuit boards 720 and 730. The display panel 710 displays an image, and the data and gate printed circuit boards 720 and 730 provide the display panel 710 with a driving signal that drives the display panel 710. The data and gate printed circuit boards 720 and 730 are electrically connected to the liquid crystal display panel 710 via data and gate tape carrier packages 740 and 750, respectively.

The liquid crystal display panel 710 includes a thin film transistor substrate 712, a color filter substrate 714 facing the thin film transistor substrate 712, and a liquid crystal layer 716 interposed between the thin film transistor substrate 712 and the color filter substrate 714.

The thin film transistor substrate 712 is a glass substrate having thin film transistor (not shown) formed thereon. The thin film transistor includes a source electrode that is electrically connected to a data line, a gate electrode that is electrically connected to a gate line, and a drain electrode that is electrically connected to a pixel electrode. The pixel electrode is optically transparent and electrically conductive.

The color filter substrate 714 is a substrate having red (R), green (G) and blue (B) color filters formed thereon, and a common electrode (not shown) that is optically transparent and electrically conductive.

The receiving container 800 includes a bottom plate 810 and a sidewall 820 protruded upward from edge of the bottom plate 810 to form a receiving space. The receiving container 800 fixes the surface light source device 100 and the liquid crystal display panel 710.

The bottom plate 810 has a sufficient area to receive the surface light source device 100, and the bottom plate 810 has substantially identical shape with the surface light source device 100. For example, both the bottom plate 810 and the surface light source device 100 have a rectangular plate shape.

The inverter 500 is disposed outside the receiving container 800. The inverter 500 generates a discharge voltage including a discharge start voltage and a discharge maintaining voltage. The discharge voltage generated from the inverter 500 is applied to the surface light source device 100 via first, second and third wires 510, 520 and 530. In detail, the first wire 510 is electrically connected to a first electrode 410 of the surface light source device 100, the second wire 520 is electrically connected to a second electrode 420 of the surface light source device 100, and the third wire 530 is electrically connected to a third electrode 430 of the surface light source device 100.

Therefore, the discharge start voltage is applied to the first and third electrodes 410 and 430 through the first and third wires 510 and 530, respectively. The discharge maintaining voltage is applied to the first and second electrodes 410 and 420 through the first and second wires 510 and 520, respectively.

The first, second and third wires 510, 520 and 530 may be directly connected to the first, second and third electrodes 410, 420 and 430, respectively. However, the first, second and third wires 510, 520 and 530 may be connected to the first, second and third electrodes 410, 420 and 430, respectively via a connecting member (not shown).

The liquid crystal display apparatus 1000 further includes a top chassis 900 and at least one optical sheet 950.

The top chassis 900 surrounds edges of the liquid crystal display panel 710, and the top chassis 900 is combined with the receiving container 800. The top chassis 900 protects and fixes the liquid crystal display panel 710.

The optical sheet 950 enhances luminance and uniformity of the luminance. The optical sheet 950 includes diffusion sheet for diffusing a light and a prism sheet for condensing a light.

According to the present invention, a discharge start voltage is applied to an electrode that overlaps with partition member, so that deflection caused by interference between the partition members is reduced. Additionally, the discharge voltage is lowered.

Furthermore, a floating electrode that overlaps with the partition member and a passage of the discharge gas to remove deflection while a discharge maintaining voltage is applied.

Having described the exemplary embodiments of the present invention and its advantages, it is noted that various changes, substitutions and alterations can be made herein without departing from the spirit and scope of the invention as defined by appended claims.

1. A surface light source device comprising:
a light source body including a plurality of partitioned discharge spaces extended in a first direction;
first and second electrodes that are disposed at each end portion of the light source body, respectively and extended in a second direction that crosses the first direction; and
a third electrode extended in the second direction, the third electrode being disposed between the first and second electrodes, such that the third electrode overlaps with the partitioned discharge spaces.

2. The surface light source device of claim 1, wherein the light source body comprises:
a first substrate;
a second substrate that faces the first substrate;
a sealing member that is disposed between the first and second substrates to form the discharge space; and
a partition member interposed between the first and second substrates to divide the discharge space into the partitioned discharge spaces.

3. The surface light source device of claim 2, wherein the first, second and third electrodes are formed on an outer surface of the second substrate.

4. The surface light source device of claim 2, wherein at least one end of the partition member is spaced apart from the sealing member.

5. The surface light source device of claim of claim 4, wherein the partition member includes a first end portion that is spaced apart from the sealing member, and a second end portion that makes contact with the sealing member.

6. The surface light source device of claim of claim 5, further comprising a fourth electrode formed on an internal surface of the second substrate, the fourth electrode being extended in the second direction.

7. The surface light source device of claim 6, wherein a portion of the fourth electrode overlaps with the second electrode that is formed on the outer surface of the second substrate.

8. The surface light source device of claim 7, wherein a portion of the fourth electrode overlaps with the first end portion of the partition member.

9. The surface light source device of claim 1, further comprising an inverter that applies a discharge voltage including a discharge start voltage and a discharge maintaining voltage to the first, second and third electrodes.

10. The surface light source device of claim 9, wherein the inverter applies the discharge start voltage to the first and third electrodes during a first time interval.

11. The surface light source device of claim 10, wherein the inverter applies the discharge maintaining voltage to the first and second electrodes after the first time interval.

12. The surface light source device of claim 11, wherein the discharge start voltage is higher than the discharge maintaining voltage.

13. The surface light source device of claim of claim 4, wherein the partition member includes first and second end portions that are spaced apart from the sealing member.

14. The surface light source device of claim of claim 13, further comprising fourth and sixth electrodes formed on an internal surface of the second substrate, and a fifth electrode formed on an outer surface of the second substrate, the fourth, fifth and sixth electrodes being extended in the second direction.

15. The surface light source device of claim 14, wherein portions of the fourth and sixth electrodes overlap with the second and first electrodes that are formed on the outer surface of the second substrate, respectively.

16. The surface light source device of claim 15, wherein portions of the fourth and sixth electrodes overlap with the first and second end portions of the partition member, respectively.

17. The surface light source device of claim 14, further comprising an inverter that applies a discharge voltage including a discharge start voltage and a discharge maintaining voltage to the first, second, third and fifth electrodes.

18. The surface light source device of claim 17, wherein the inverter applies the discharge start voltage to the third and fifth electrodes during a first time interval.

19. The surface light source device of claim 18, wherein the inverter applies the discharge maintaining voltage to the first and second electrodes after the first time interval.

20. The surface light source device of claim 19, wherein the discharge start voltage is higher than the discharge maintaining voltage.

21. The surface light source device of claim 2, further comprising first and second fluorescent layers formed on internal surfaces of the first and second substrates, respectively.

22. A liquid crystal display apparatus comprising:
a surface light source device that generates a light, the surface light source device including a light source body having a plurality of partitioned discharge spaces extended in a first direction, first and second electrodes that are disposed at each end portion of the light source body, respectively and extended in a second direction that crosses the first direction, and a third electrode extended in the second direction, the third electrode being disposed between the first and second electrodes, such that the third electrode overlaps with the partitioned discharge spaces;
a liquid crystal display panel that displays an image by using the light generated from the surface light source device; and
an inverter that applies discharge voltage including a discharge start voltage and a discharge maintaining voltage to the first, second and third electrodes.

23. The liquid crystal display apparatus of claim 22, wherein the light source body comprises a first substrate, a second substrate that faces the first substrate, a sealing member that is disposed between the first and second substrates to form the discharge space, a partition member interposed between the first and second substrates to divide the discharge space into the partitioned discharge spaces and the first, second and third electrodes are formed on an outer surface of the second substrate.

24. The liquid crystal display apparatus of claim 23, wherein the partition member is extended in the first direction, and at least one end of the partition member is spaced apart from the sealing member.

25. The liquid crystal display apparatus of claim 24, wherein the first, second and third electrodes are extended in a second direction that is substantially perpendicular to the first direction.

26. The liquid crystal display apparatus of claim 22, wherein the inverter applies the discharge start voltage to the first and third electrodes during a first time interval, and the inverter applies the discharge maintaining voltage that is lower than the discharge start voltage to the first and second electrodes after the first time interval.

27. The liquid crystal display apparatus of claim 23, further comprising a fourth electrode formed on an internal surface of the second substrate, the fourth electrode overlapping with the second electrode.

28. The liquid crystal display apparatus of claim 27, wherein a portion of the fourth electrode overlaps with the partition member.
